(19) United States
(12) Patent Application Publication
(10) Pub. No.: US 2026/0017713 A1
(43) Pub. Date: Jan. 15, 2026

(54) METHOD AND APPARATUS FOR MEDIATING INFORMATION RELATED TO TRANSFER OF ASSETS

(71) Applicant: Dunamu Inc., Seoul (KR)

(72) Inventors: Min Seok Jung, Seoul (KR); Ye Ji Han, Seoul (KR)

(73) Assignee: Dunamu Inc., Seoul (KR)

(21) Appl. No.: 19/257,560

(22) Filed: Jul. 2, 2025

(30) Foreign Application Priority Data
Jul. 10, 2024 (KR) 10-2024-0091368

(51) Int. Cl. G06Q 40/04; G06Q 20/10

(52) U.S. Cl. CPC G06Q 40/04; G06Q 20/10

(57) ABSTRACT

A method, performed by an electronic device, of mediating information related to transfer of assets includes receiving first information related to a request for the transfer of the assets from a first user of a first exchange to a second user of a second exchange, freezing a portion corresponding to the assets for which the transfer is requested from a reserve fund of the first exchange, based on the first information, transmitting the first information to the second exchange, and performing a settlement process based on second information corresponding to a result of the transfer of the assets.

### CROSS-REFERENCE TO RELATED APPLICATION

This application is based on and claims priority under 35 U.S.C. § 119 to Korean Patent Application No. 10-2024-0091368, filed on Jul. 10, 2024, in the Korean Intellectual Property Office, the disclosure of which is incorporated by reference herein in its entirety.

### BACKGROUND

### 1. Field

The disclosure relates to a method and apparatus for mediating information related to transfer of assets.

### 2. Description of the Related Art

Recently, services which allow various types of assets to be traded through online platforms have been provided. Users can transfer at least a portion of their assets to others through such platforms.

The transfer of assets from a first user to a second user is completed when the assets are withdrawn from the first user's account (or wallet) and deposited into the second user's account (or wallet). However, when the asset transfer process involves multiple steps or procedures, the asset transfer process may take a long time.

### SUMMARY

Virtual asset markets are not yet fully matured. For example, various transaction-related incidents occur. Accordingly, various regulations and supplementary procedures exist to improve trust between users, between exchanges, or between users and exchanges. The regulations and supplementary procedures involve the process of information exchange and mutual confirmation between transaction entities by using blockchains or transaction mediators. Such a process causes significant delays in the transaction process of virtual assets. For instance, when virtual assets are transferred, multiple steps must be executed on the blockchain network to finalize the transaction. These include transaction creation, propagation, and validation, followed by block creation, propagation, and consensus. Each of these steps may introduce latency, and any delay or error in a single step can significantly prolong the overall transaction time. As a result, the time required for users to confirm whether the virtual asset transfer has been successfully completed may increase, potentially leading to greater uncertainty and anxiety for users.

At least some of various embodiments described herein are intended to technically solve the above-described technical problems.

To address these problems, the disclosure provides a method and apparatus for mediating information related to transfer of assets. Furthermore, the disclosure provides a computer-readable recording medium having recorded thereon a program for causing a computer to perform the method.

According to the method and apparatus described above, the withdrawal may be immediately reflected in an account (or wallet) of the originator and the deposit may be immediately reflected in an account (or wallet) of the beneficiary. Furthermore, the time required for transferring assets from the perspective of users, including both the originator and the beneficiary, may be reduced.

A method, performed by an electronic device, of mediating information related to transfer of assets, according to an aspect, includes receiving first information related to a request for the transfer of the assets from a first user of a first exchange to a second user of a second exchange, freezing a portion of a reserve fund (i.e., security deposit or guarantee deposit) of the first exchange, based on the first information, transmitting the first information to the second exchange, and performing a settlement process based on second information corresponding to a result of the transfer of the assets.

A computer-readable recording medium according to another aspect includes a recording medium having recorded thereon a program for causing a computer to perform the above-described method.

An electronic device according to another aspect includes a memory in which at least one program is stored, and a processor configured to execute the at least one program to perform at least one operation, wherein the processor is further configured to obtain first information related to a request for transfer of assets from a first user of a first exchange to a second user of a second exchange, freeze a portion of a reserve fund of the first exchange, based on the first information, transmit the first information to the second exchange, and perform a settlement process based on second information corresponding to a result of the transfer of the assets.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a diagram illustrating an example of an asset transfer process according to an embodiment;

FIG. 2 is a configuration diagram illustrating an example of a server according to an embodiment;

FIG. 3 is a flowchart showing an example of a method of mediating information related to transfer of assets, according to an embodiment;

FIG. 4 is a diagram illustrating an example in which a processor freezes at least a portion of a reserve fund of a first exchange, according to an embodiment;

FIG. 5 is a diagram illustrating an example in which a processor confirms a first process and a second process, according to an embodiment;

FIG. 6 is a diagram illustrating an example in which a processor performs a settlement process according to the actual aspect of transfer of assets, according to an embodiment;

FIG. 7 is a diagram illustrating an example in which a processor receives second information and performs a settlement process, according to an embodiment;

FIG. 8 is a diagram illustrating an example of a request for travel rule verification and third information, according to an embodiment;

FIG. 9 is a diagram illustrating another example of a method of mediating information related to transfer of assets, according to an embodiment;

FIG. 10 is a flowchart showing another example of a method of mediating information related to transfer of assets, according to an embodiment;

FIG. 11 is a diagram illustrating another example in which a processor performs a settlement process according to the actual aspect of transfer of assets, according to an embodiment; and

FIG. 12 is a diagram illustrating another example in which a processor receives second information and performs a settlement process, according to an embodiment.

### DETAILED DESCRIPTION

As for the terms used in embodiments, commonly accepted terms are selected whenever possible. However, the terms may vary depending on the intent of those of ordinary skill in the art, precedents, the emergence of new technology, and the like. In certain cases, there are also terms arbitrarily selected by the applicant. In such cases, the meaning of the terms will be described in detail in the description of the disclosure. Therefore, terms used in the specification should be defined based on the meaning of the terms and the overall description of the specification, not just the names of the terms.

Throughout the specification, the expression “a portion includes a certain element” means that the portion may include additional elements as well, unless explicitly stated otherwise. Also, the terms such as “unit” and “module” described in the specification refer to elements that perform at least one function or operation, and may be implemented as hardware, software, or a combination of hardware and software.

It will be understood that although the terms including ordinal numbers, such as “first” or “second,” may be used to describe various elements, these elements should not be limited by these terms. These terms are only used to distinguish one element from another.

Hereinafter, embodiments will be described in detail with reference to the accompanying drawings. However, the embodiments may be implemented in various forms and are not limited to the examples described herein.

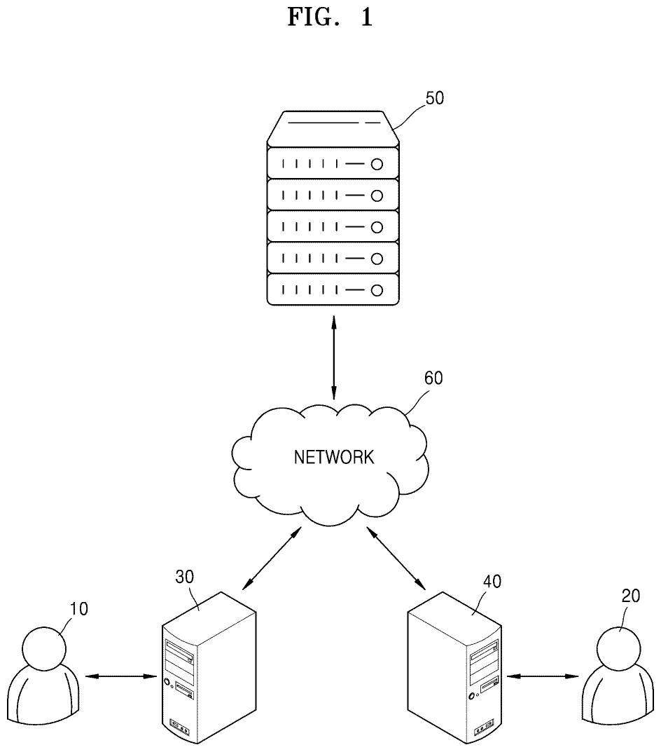

FIG. 1 is a diagram illustrating an example of an asset transfer process according to an embodiment.

In FIG. 1, a first user 10, a second user 20, a first exchange 30, a second exchange 40, and an electronic device 50 are illustrated. The first exchange 30, the second exchange 40, and the electronic device 50 may be connected to each other through a network 60.

The first exchange 30 and the second exchange 40 may provide online platforms which enable assets to be managed and traded. Examples of the online platforms may include a program (e.g., a trading system, etc.) which enables assets to be traded through a user terminal (e.g., a notebook personal computer (PC), a desktop PC, a laptop, a tablet computer, a smartphone, etc.). Accordingly, the first user 10 and the second user 20 may access the online platforms provided by the first exchange 30 and the second exchange 40 through software (e.g., an application) installed on the user terminal.

Hereinafter, the first user 10 and the second user 20 are described as managing and trading assets through the first exchange 30 and the second exchange 40, respectively. The trading may include the transfer, remittance, or deposit of assets. Furthermore, the remittance of assets may be the same action as the withdrawal of assets. As used herein, the expression “the withdrawal of assets from the first exchange 30 has been completed” may be understood as meaning that the movement of assets from the first exchange 30 to the second exchange 40, for example, via a blockchain, has been successful. Accordingly, as used herein, the expression “the withdrawal of assets from the first exchange 30 has been completed” may be understood as meaning that the deposit of assets into the second exchange 40 has been completed.

For example, the assets may include stocks, minerals (e.g., gold, silver, copper, etc.), virtual assets, etc. Virtual assets may include, for example, non-fungible tokens (NFTs) or digital assets such as Bitcoin, Ethereum, Tether, etc. In some embodiments, there are no restrictions on the types of financial products (e.g., stocks, futures, options, etc.) for assets, as long as the financial products may be traded on the online platforms.

The first exchange 30 and the second exchange 40 may provide the online platforms by using a server. Hereinafter, unless otherwise specified, the first exchange 30 and the second exchange 40 may be asset business operators and may be referred to as a server of the first exchange 30 and a server of the second exchange 40, respectively.

For example, if that the assets are virtual assets, the first exchange 30 and the second exchange 40 may be virtual asset service providers (VASPs) and may also refer to servers of the VASPs, respectively. In some embodiments, a mediator may be a business which provides solutions such as Verify VASP or CODE. In an embodiment, a server of the mediator may be, for example, the electronic device 50 of FIG. 1.

If the assets for which the transfer is requested meet certain criteria, a travel rule may be applied. The travel rule refers to a rule which requires the first exchange 30 and the second exchange 40, which are VASPs, to mutually confirm information about an originator and information about a beneficiary when transferring assets, so as to prevent money laundering using assets. For example, if the value (amount) of the assets to be transferred exceeds a certain threshold, the asset transfer process may be subject to the travel rule.

For example, assuming that the assets are virtual assets and the process of transferring the assets from the first user 10 to the second user 20 is subject to the travel rule, the mediator may confirm information about the first user 10 and information about the second user 20.

For example, if the first user 10 remits the assets to the second user 20, the mediator may notify the first exchange 30 and the second exchange 40 of the confirmation of the information about the first user 10 and the information about the second user 20. Thereafter, if the transaction for the remittance is recorded on a blockchain, the mediator may notify the second exchange 40 of the record of the transaction. Then, the second exchange 40 may reflect the deposit in the account (or wallet) of the second user 20.

The expression “the deposit is reflected in the account (or wallet) of the second user 20” may mean that an increase in assets is reflected in the account (or wallet) of the second user 20. In other words, if the first user 10 remits the assets to the second user 20, the deposit may be reflected in the account (or wallet) of the second user 20 after the withdrawal of the assets from the first exchange 30 and the deposit of the assets into the second exchange 40 have been actually completed.

According to the above-described process, in order for the deposit to be finally reflected in the account (or wallet) of the second user 20, it may take time for the transaction to be recorded on the blockchain. If the recording of the transaction is delayed due to an error in the network 60, etc., it may take more time until the deposit is finally reflected in the account (or wallet) of the second user 20.

In some embodiments, the first exchange 30 and the second exchange 40 may each have different numbers of confirmations on the blockchain required for the deposit or withdrawal to be reflected. Accordingly, even if the first exchange 30 provides a notification to the first user 10 that the withdrawal process has been complete (e.g., a decrease in assets is reflected in the account (or wallet) of the first user 10 in the first exchange 30) because the number of confirmations is satisfied, the second exchange 40 may not provide a notification to the second user 20 that the deposit process has been completed (e.g., an increase in assets is reflected in the account (or wallet) of the second user 20 in the second exchange 40) because the number of confirmations is not satisfied. Accordingly, the first user 10 and the second user 20 may misunderstand that the transfer of assets has not been normally performed.

The electronic device 50 according to an embodiment may freeze assets corresponding to a portion of the reserve fund of the first exchange 30, based on a request for the transfer of the assets from the first exchange 30 to the second exchange 40. The electronic device 50 may perform a settlement process based on second information corresponding to the result of transferring the assets. In other words, the electronic device 50 may perform the settlement process based on the actual aspect of the transfer of the assets.

Accordingly, even if the recording and confirmation of the remittance on the blockchain is not completed, a decrease in assets in the account (or wallet) of the first user 10 and an increase in assets in the account (or wallet) of the second user 20 may be quickly performed with only a transfer request for the assets of the first user 10. Accordingly, the time required for transferring the assets between the first user 10 and the second user 20 may be reduced.

For example, the electronic device 50 may be a computing device of the mediator. In some embodiments, the electronic device 50 may be a computing device of the first exchange 30 or the second exchange 40. For example, the electronic device 50 may be configured as part of one or more servers of the first exchange 30, or as part of one or more servers of the second exchange 40.

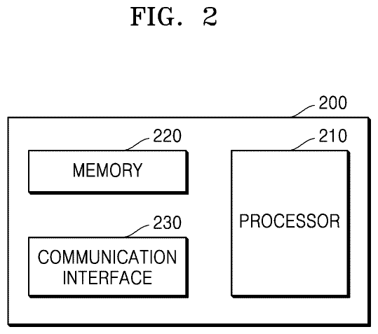

Hereinafter, the electronic device 50 of FIG. 1 may be the server 200 of FIG. 2. The operation of the electronic device 50 may be implemented by a single device (e.g., the user terminal or the server 200) or more devices.

The server 200 may be a device which communicates with an external device (not shown) including the user terminal. For example, the server 200 may be a device which stores various data. In some embodiments, the server 200 may be a computing device which includes a memory and a processor and has its own computing capabilities. For example, the server 200 may be a cloud server, but the disclosure is not limited thereto.

In some embodiments, all or part of the operations performed by the electronic device 50 may be performed by a processor 210 of FIG. 2. In other words, all or part of the operations described as being performed by the electronic device 50 may be performed by the processor 210.

Hereinafter, examples in which the electronic device 50 mediates information related to transfer of assets will be described with reference to FIGS. 2 to 9.

The examples to be described below with reference to FIGS. 2 to 9 may be implemented as functions provided by an asset trading program (e.g., a trading system, etc.). For example, if the first user 10 or the second user 20 selects a certain menu (or function) through software (e.g., an application) installed on the user terminal, the electronic device 50 may perform operations according to the examples described below with reference to FIGS. 2 to 9. In some embodiments, the electronic device 50 may perform operations according to the examples described below with reference to FIGS. 2 to 9, without any intervention of the first user 10 or the second user 20, according to an agreement between the first exchange 30 and the second exchange 40.

FIG. 2 is a configuration diagram illustrating an example of a server 200 according to an embodiment.

Referring to FIG. 2, the server 200 may include a processor 210, a memory 220, and a communication interface 230. For convenience of explanation, only components related to the disclosure are illustrated in FIG. 2. Accordingly, in addition to the components illustrated in FIG. 2, other general-purpose components may be further included in the server 200. It is obvious to those of ordinary skill in the art that the processor 210, the memory 220, the communication interface 230 illustrated in FIG. 2 may be implemented as independent devices.

The processor 210 may process commands of a computer program by performing basic arithmetic, logic, and input/output operations. The commands may be provided from the memory 220 or the external device (not shown). In some embodiments, the processor 210 may control the overall operations of other components included in the server 200.

The processor 210 may obtain first information related to a request for the transfer of the assets from the first user 10 of the first exchange 30 to the second user 20 of the second exchange 40. The request for the transfer of the assets from the first user 10 to the second user 20 may be a request for the transfer of the assets through a blockchain. For example, the processor 210 may receive the first information from the first exchange 30 through the communication interface 230. The request for the transfer of the assets may include a request for transfer of assets corresponding to a preset amount (e.g., 1 million won) or more. For example, a request for the transfer of the assets may include a request subject to a travel rule established for the transfer of the assets.

The first information may be information related to the transfer of the assets from the first user 10 to the second user 20. In other words, the first information may be the basis for updating the balance of the second exchange 40 for the second user 20. For example, if the assets are virtual assets, the first information may include information about at least one of an identifier corresponding to travel rule verification, the second exchange, the second user, an address of the wallet of the second user in the second exchange, the type of the assets for which the transfer is requested, the quantity of the assets for which the transfer is requested, the first user, an address of the wallet of the first user in the first exchange, or an identifier corresponding to the request for the transfer of the assets.

The identifier corresponding to the request for the transfer of the assets is information indicating a quick withdrawal request from the first user 10, and may be an identifier corresponding to a withdrawal request through the blockchain of the first exchange 30. For example, the identifier corresponding to the request for the transfer of the assets may be an identifier generated to indicate a response to the withdrawal request made by the first exchange 30 through the blockchain. Accordingly, the identifier corresponding to the request for the transfer of the assets may indicate that the first exchange 30 has requested the withdrawal of the assets through the blockchain.

The processor 210 may freeze a portion corresponding to the assets for which the transfer is requested from the reserve fund of the first exchange 30, based on the first information. The first information may be the basis for updating the balance of the second exchange 40 for the second user 20. For example, the reserve fund of the first exchange 30 may be assets owned by the first exchange 30 and deposited to the server 200 by the first exchange 30.

The processor 210 may transmit the first information to the second exchange 40. For example, the processor 210 may transmit the first information to the second exchange 40 on the premise of freezing a portion corresponding to the assets for which the transfer is requested from the reserve fund of the first exchange 30, based on the first information. For example, the processor 210 may transmit the first information to the second exchange 40 simultaneously with or subsequent to freezing the reserve fund of the first exchange 30. In another example, the processor 210 may freeze the reserve fund of the first exchange 30 after transmitting the first information to the second exchange 40. Upon receiving the first information from the electronic device 50, the second exchange 40 may predict that the transfer of the assets from the first exchange 30 to the second exchange 40 will occur. For example, the second exchange 40 may predict that the transfer of the assets from the first exchange 30 to the second exchange 40 through the blockchain will be successful or may predict that the frozen reserve fund of the first exchange 30 will be transferred to the reserve fund of the second exchange 40, through the identifier corresponding to the request for the transfer of the assets, which is included in the first information.

The processor 210 may perform a settlement process based on second information corresponding to the result of transferring the assets. In other words, the processor 210 may perform a settlement process based on the actual aspect of the transfer of the assets. For example, the processor 210 may process the frozen portion (i.e., the frozen portion of the deposit in the first exchange 30) based on whether the withdrawal of the assets for which the transfer is requested has been completed at the first exchange 30. For example, if the withdrawal of the assets for which the transfer is requested is not completed at the first exchange 30, the processor 210 may move the frozen portion of the deposit of the first exchange 30 to the reserve fund of the second exchange 40.

For example, the processor 210 may perform a settlement process based on the second information corresponding to the result of transferring the assets. In other words, the processor 210 may confirm the actual aspect of the transfer of the assets, based on the second information. The second information may include a transaction hash generated upon completion of the transfer of the assets for which the transfer is requested. For example, if the second information includes the transaction hash, the processor 210 may determine that the transfer actually occurred, and if the second information does not include the transaction hash, the processor 210 may determine that no transfer actually occurred.

In some embodiments, the processor 210 may confirm the first process and the second process before obtaining the second information. For example, the first process is a process of the first exchange 30 related to the assets for which the transfer is requested. The first process may include a process in which a decrease in assets for which the transfer is requested is reflected in the account (or wallet) of the first user 10 in the first exchange 30. In some embodiments, the second process is a process of the second exchange 40 related to the assets for which the transfer is requested. The second process may include a process in which an increase in assets for which the transfer is requested is reflected in the account (or wallet) of the second user 20 in the second exchange 40. Upon completion of the first process, the first user 10 may confirm that the process of transferring the assets for which the transfer is requested is in progress or has been completed, and upon completion of the second process, the second user 20 may confirm that the process of transferring the assets for which the transfer is requested has been completed.

In some embodiments, the processor 210 may receive a request for travel rule verification and third information from the first exchange 30 before obtaining the first information. The third information may include information about at least one of the second exchange 40, the second user 20, the address of the wallet of the second user 20 in the second exchange 40, the type of the assets for which the transfer is requested, and the quantity of the assets for which the transfer is requested.

The processor 210 may be implemented as an array of a plurality of logic gates, or may be implemented as a combination of a general-purpose microprocessor and a memory storing a program which is executable on the microprocessor. Examples of the processor 210 may include a general-purpose processor, a central processing unit (CPU), a microprocessor, a digital signal processor (DSP), a controller, a microcontroller, a state machine, or the like. In some environments, the processor 210 may include an application-specific integrated circuit (ASIC), a programmable logic device (PLD), a field programmable gate array (FPGA), or the like. For example, the processor 210 may be a combination of processing devices, for example, a combination of a DSP and a microprocessor, a combination of a plurality of microprocessors, a combination of one or more microprocessors connected to a DSP core, or a combination of any other configurations.

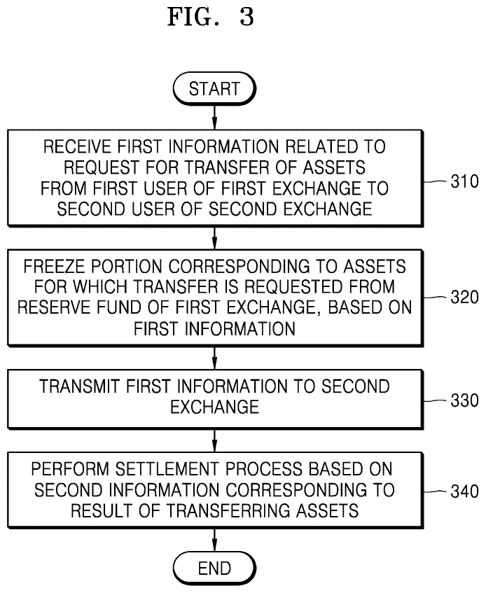

The memory 220 may include any non-transitory computer-readable recording medium. As an example, the memory 220 may include a permanent mass storage device, such as random access memory (RAM), read-only memory (ROM), disk drive, solid state drive (SSD), or flash memory. As another example, the permanent mass storage device, such as ROM, SSD, flash memory, or disk drive, may be a separate permanent storage device distinct from memory. The memory 220 may store an operating system (OS) and at least one program code (e.g., code for causing the processor 210 to perform operations to be described below with reference to FIGS. 3 to 9).

Such software components may be loaded from a computer-readable recording medium separate from the memory 220. The separate computer-readable recording medium may be a recording medium which may be directly connected to the server 200. Examples of the separate computer-readable recording medium may include floppy drive, disk, tape, digital versatile disc (DVD), compact disc read-only memory (CD-ROM) drive, and memory card. For example, the software components may be loaded into the memory 220 through the communication interface 230 rather than the computer-readable recording medium. For example, the at least one program may be loaded into the memory 220, based on a computer program installed by files provided through the communication interface 230 by developers or a file distribution system which distributes an application installation file (e.g., a computer program for causing the processor 210 to perform operations described below with reference to FIGS. 3 to 9).

The communication interface 230 may provide a component or function configured to communicate with external devices through the network 60. For example, control signals, commands, data, and the like, which are provided under the control by the processor 210, may be transmitted to the external device through the communication interface 230 and the network 60.

Although not illustrated in FIG. 2, the server 200 may further include an input/output interface. The input/output interface may be a means for interfacing with an input or output device (e.g., a keyboard, a mouse, etc.) which may be connected to or included in the server 200. For example, the input/output interface may be configured separately from the processor 210, or may be configured to be included in the processor 210.

Although not illustrated in FIG. 2, the server 200 may further include a display device. For example, the server 200 may be connected to an independent display device in a wired or wireless communication scheme and may transmit and receive data therebetween.

FIG. 3 is a flowchart showing an example of a method of mediating information related to transfer of assets, according to an embodiment.

The method illustrated in FIG. 3 may include operations which are processed in time series by the electronic device 50, the server 200, or the processor 210 illustrated in FIGS. 1 and 2. Therefore, even when omitted below, the description of the electronic device 50, the server 200, or the processor 210 illustrated in FIGS. 1 and 2 may also be applied to the method illustrated in FIG. 3.

In operation 310, the processor 210 may receive first information related to a request for the transfer of the assets from the first user 10 of the first exchange 30 to the second user 20 of the second exchange 40.

For example, if the first user 10 requests a remittance to the second user 20 from the first exchange 30, the first exchange 30 may transmit the first information to the electronic device 50 (or the server 200). Accordingly, the processor 210 may obtain the first information. The processor 210 may receive the first information from the first exchange 30 through the communication interface 230.

The first information may be the basis for updating the balance of the second exchange 40 for the second user 20. For example, the first information may include information about at least one of the identifier corresponding to travel rule verification, the second exchange 40, the second user 20, the address of the wallet of the second user 20 in the second exchange 40, the type of the assets for which the transfer is requested, the quantity of the assets for which the transfer is requested, the first user 10, the address of the wallet of the first user 10 in the first exchange 30, or the identifier corresponding to the request for the transfer of the assets. For example, the identifier corresponding to travel rule validation may be a universally unique identifier (UUID). For example, the first information may be generated by the first exchange 30.

The request for the transfer of the assets may include a request for transfer of assets corresponding to a preset amount (e.g., 1 million won) or more. In some embodiments, the request for the transfer of the assets may include a request subject to a travel rule.

If the assets for which the transfer is requested are virtual assets and the market price of the assets for which the transfer is requested is a preset amount or more, or if the request for the transfer of the assets is subject to the travel rule, the first exchange 30 may transmit the first information to the electronic device 50. In this case, the identifier corresponding to the request for the transfer of the assets, which is included in the first information, may be a type of transaction identifier (ID). For example, the identifier corresponding to the request for the transfer of the assets may be an identifier generated by the first exchange 30 so as to quickly withdraw the assets from the wallet of the first user 10, or an identifier indicating the quick withdrawal request from the first user 10.

As an example, if the assets for which the transfer is requested corresponds to a preset amount (e.g., 1 million won) or more, or if the request for the transfer of the assets is subject to the travel rule, the processor 210 may automatically perform operations 310 to 340.

As another example, if the assets for which the transfer is requested corresponds to a preset amount (e.g., 1 million won) or more, or if the request for the transfer of the assets is a request subject to the travel rule and the first user 10 inputs a separate request through the first exchange 30, the processor 210 may perform operations 310 to 340. For example, the separate request from the first user 10 may be implemented by a method in which the first user 10 selects a separate menu (or function) through software (e.g., an application) installed on the user terminal.

In operation 320, the processor 210 may freeze a portion corresponding to the assets for which the transfer is requested from the reserve fund of the first exchange 30, based on the first information.

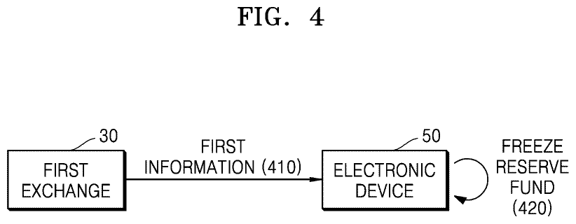

For example, the processor 210 may freeze at least a portion of the reserve fund of the first exchange 30 in response to receiving the first information. For example, if the first information includes specified information, the processor 210 may freeze at least a portion of the reserve fund of the first exchange 30. In an embodiment, if the first information includes information indicating the quick withdrawal request from the first user 10, for example, the identifier corresponding to the request for the transfer of the assets, the processor 210 may freeze at least a portion of the reserve fund of the first exchange 30. Hereinafter, an example in which the processor 210 freezes at least a portion of the reserve fund of the first exchange 30 is described with reference to FIG. 4.

FIG. 4 is a diagram illustrating an example in which the processor 210 freezes at least a portion of the reserve fund of the first exchange 30, according to an embodiment.

Referring to FIG. 4, if the first exchange 30 transmits first information to the electronic device 50 (410), the processor 210 may freeze at least a portion of the reserve fund of the first exchange 30 (420). For example, the processor 210 may notify the first exchange 30 that at least a portion of the reserve fund of the first exchange 30 has been frozen (420).

Assume that the first user 10 wishes to transfer N “A” coins (where N is a positive real number) to the second user 20. The market price of N “A” coins is a preset amount or more, or the transfer of N “A” coins is subject to the travel rule.

The reserve fund of the first exchange 30 may be previously deposited in the electronic device 50 or a storage which is controlled by the electronic device 50. For example, the reserve fund may include a certain amount of each of various assets traded through the first exchange 30. In this case, the processor 210 may freeze N “A” coins among the reserve fund of the first exchange 30. Accordingly, even if a problem occurs in which N “A” coins of the first user 10 are not actually transferred to the second user 20, the transaction desired by the first user 10 may be normally completed based on the frozen reserve fund of the first exchange 30.

Referring again to FIG. 3, in operation 330, the processor 210 may transmit the first information to the second exchange 40.

Upon receiving the first information, the second exchange 40 may confirm that the first user 10 has requested the transfer of the assets to the second user 20. Accordingly, the second process to be described below may be performed at the second exchange 40.

In operation 340, the processor 210 may perform a settlement process based on the second information corresponding to the result of transferring the assets.

For example, the processor 210 may determine the actual aspect of the transfer of the assets, based on the second information. The processor 210 may perform the settlement process based on the determination result (i.e., the actual aspect of the transfer of the assets).

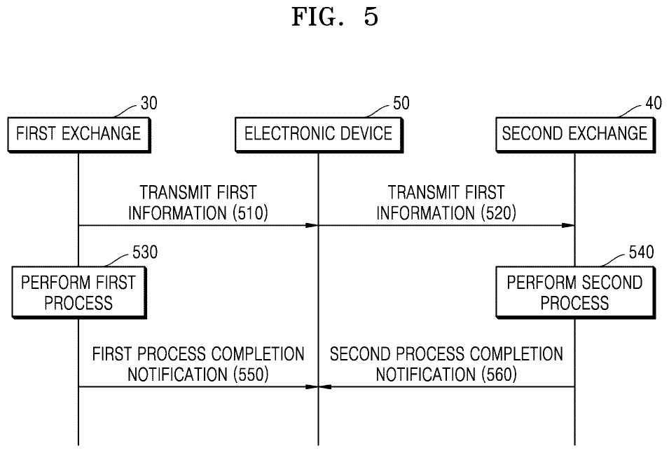

The actual aspect may refer to whether the assets have been actually transferred from a representative account (or wallet) of the first exchange 30 to a representative account (or wallet) of the second exchange 40. The representative account (or wallet) of the exchange may be understood as an account (or wallet) owned by an exchange which is communicatively connected to a blockchain network. In some embodiments, the actual aspect may refer to whether the assets have been actually transferred from the account (or wallet) of the first user 10 to the account (or wallet) of the second user 20. As described below with reference to FIG. 5, the first exchange 30 and the second exchange 40 may perform the first process and the second process, regardless of whether the assets have been actually withdrawn from the account (or wallet) of the first user 10 and deposited into the account (or wallet) of the second user 20, or regardless of whether the asset movement through the blockchain between the first exchange 30 and the second exchange 40 has actually occurred. Accordingly, if the assets are not actually transferred from the account (or wallet) of the first user 10 to the account (or wallet) of the second user 20 due to any circumstances, the first exchange 30 or the second exchange 40 may incur unexpected losses.

Because the processor 210 performs the settlement process based on the actual aspect of the transfer of the assets, damage to the first exchange 30 or the second exchange 40 may be prevented. Additionally, by reducing the time required for users to confirm the completion of asset transfers through the first and second processes, the method may enhance user experience and confidence in the transaction.

The settlement process may include a process for the portion frozen in operation 320 (i.e., at least a portion of the reserve fund of the first exchange 30). For example, the processor 210 may process the frozen portion based on whether the withdrawal of the assets for which the transfer is requested has been completed at the first exchange 30. If the withdrawal of the assets for which the transfer is requested has not been completed at the first exchange 30, the processor 210 may move the frozen portion to the reserve fund of the second exchange 40.

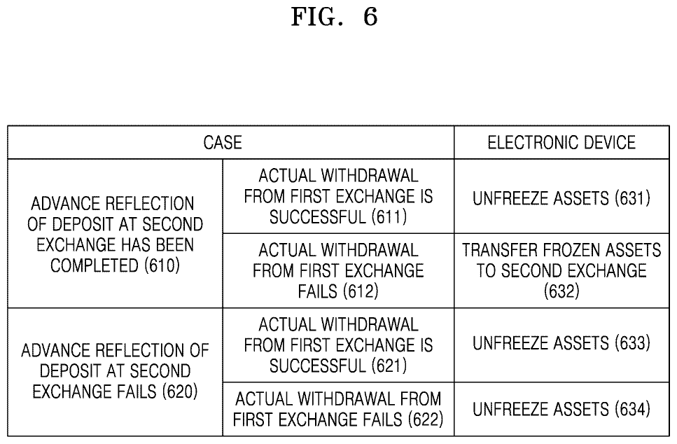

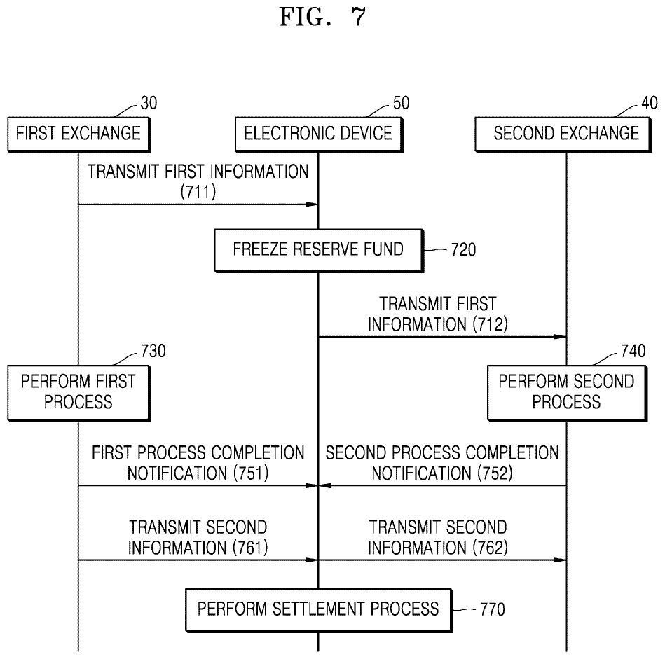

For example, the second information may include a transaction hash generated upon completion of the transfer of the assets for which the transfer is requested. For example, the transaction hash may be generated upon completion of the transfer of the assets from the first exchange 30 to the second exchange 40 through the blockchain. Hereinafter, an example in which the processor 210 performs the settlement process is described below with reference to FIGS. 6 and 7.

Although not illustrated in FIG. 3, the processor 210 may confirm the first process of the first exchange 30 related to the assets for which the transfer is requested and the second process of the second exchange 40 related to the assets for which the transfer is requested. For example, the processor 210 may confirm the first process and/or the second process before obtaining the second information, but the disclosure is not limited thereto.

For example, the first process may include a process in which a decrease in assets for which the transfer is requested is reflected in the wallet (or account) of the first user 10 in the first exchange 30. In some embodiments, the second process may include a process in which an increase in assets for which the transfer is requested is reflected in the wallet (or account) of the second user 20 in the second exchange 40. Hereinafter, an example in which the processor 210 confirms the first process and the second process is described with reference to FIG. 5.

FIG. 5 is a diagram illustrating an example in which the processor 210 confirms the first process and the second process, according to an embodiment.

Referring to FIG. 5, the first exchange 30 may transmit first information to the electronic device 50 (510). The electronic device 50 may transmit the first information to the second exchange 40 (520). As described above with reference to FIG. 3, the first information may include information about the second user 20, information about the address of the wallet of the second user 20 in the second exchange 40, and the like. Accordingly, the second exchange 40 may confirm the first information to determine whether the information about the second user 20 and the information about the wallet of the second user 20 exist in data of the second exchange 40.

In some embodiments, the electronic device 50 may freeze a portion of the reserve fund of the first exchange 30 in response to receiving the first information from the first exchange 30, and may transmit the first information to the second exchange 40 after freezing a portion of the reserve fund of the first exchange 30. Accordingly, upon receiving the first information from the electronic device 50, the second exchange 40 may recognize the freezing of a portion of the reserve fund of the first exchange 30 or the progress (or schedule) of transferring the assets from the first exchange 30 to the second exchange 40.

Although FIG. 5 illustrates that the first exchange 30 performs the first process (530) after transmitting the first information to the electronic device 50 (510), the disclosure is not limited thereto. Alternatively, the first exchange 30 may perform the first process (530) before transmitting the first information to the electronic device 50 (510). If the first exchange 30 determines that there is no problem in withdrawing the assets from the wallet of the first user 10, the first exchange 30 may perform the first process even before transmitting the first information to the electronic device 50. For example, the first exchange 30 may determine that there is no problem in withdrawing the assets from the wallet of the first user 10 by checking the withdrawal limit preset in the wallet of the first user 10 or performing authentication on the first user 10. In some embodiments, the first exchange 30 may perform the first process (530) after receiving a second process completion notification from the electronic device 50, unlike as illustrated in FIG. 5. For example, the electronic device 50 may receive the second process completion notification from the second exchange 40 (560) and transmit the second process completion notification to the first exchange 30. The first exchange 30 may confirm that the second process has been completed at the second exchange 40 and may perform the first process (530).

The second exchange 40 may perform the second process (540) after receiving the first information. As illustrated in FIG. 5, the first exchange 30 and the second exchange 40 may each perform the asset withdrawal process (i.e., the first process) and the asset deposit process (i.e., the second process) after transmitting and receiving only the first information. Accordingly, before the confirmation of the asset transfer from the first exchange 30 to the second exchange 40 via the blockchain is completed, the reflection of the withdrawal from the account (or wallet) of the first user 10 and the reflection of the deposit into the account (or wallet) of the second user 20 may be immediately performed.

Thereafter, the first exchange 30 may notify the electronic device 50 that the first process has been completed (550). In some embodiments, the second exchange 40 may notify the electronic device 50 that the second process has been completed (560). Accordingly, the processor 210 may confirm the first process of the first exchange 30 and the second process of the second exchange 40.

FIG. 6 is a diagram illustrating an example in which the processor 210 performs the settlement process according to the actual aspect of the transfer of the assets, according to an embodiment.

As described above with reference to FIG. 3, the processor 210 may perform the settlement process depending on whether the withdrawal of the assets for which the transfer is requested has been completed at the first exchange 30. In other words, the processor 210 may perform the settlement process according to the actual success or failure of the withdrawal from the first exchange 30.

FIG. 6 illustrates cases 611, 612, 621, and 622 related to the actual success and failure of the withdrawal from the first exchange 30. However, the cases 611, 612, 621, and 622 shown in FIG. 6 include cases where it is considered whether the advance reflection (the second process) of the deposit at the second exchange 40 has been completed. Accordingly, regardless of whether the advance reflection of the deposit at the second exchange 40 has been completed, the electronic device 50 may perform the settlement process depending on whether the withdrawal has been actually completed at the first exchange 30. In other words, the processor 210 may trust that the second exchange 40 will perform the second process as the processor 210 transmits the first information to the second exchange 40, and may perform the settlement process based only on the success or failure of the asset transfer without confirmation of the second process. In other words, the first information may serve as the basis for updating the balance of the second exchange 40 for the second user 20.

Hereinafter, it is assumed that the assets for which the transfer is requested are virtual assets. Among the cases 611, 612, 621, and 622, cases 611 and 612 may occur when the advance reflection of the deposit at the second exchange 40 has been completed (610), and the remaining cases 621 and 622 may occur when the advance reflection of the deposit at the second exchange 40 fails (620). The processor 210 may confirm whether the advance reflection of the deposit at the second exchange 40 has been completed through the second process completion notification (the second process completion notification (560) of FIG. 5) from the second exchange 40.

If the advance reflection of the deposit at the second exchange 40 fails (620) and the withdrawal from the first exchange 30 is successful (621), the processor 210 may unfreeze the assets of the first exchange 30 (633). Because the assets have been actually withdrawn from the first exchange 30, the corresponding assets will be deposited into the second exchange 40. Therefore, as the assets are deposited, the second exchange 40 may perform the process of depositing the assets into the account (or wallet) of the second user 20 without any intervention of the electronic device 50. The transactions that have been withdrawn or deposited are reflected on the blockchain, and the transaction hash exists accordingly.

If the advance reflection of the deposit at the second exchange 40 fails (620), the processor 210 may unfreeze the assets of the first exchange 30 (634) even when the withdrawal from the first exchange 30 fails (622). In other words, because no assets have been actually withdrawn from the first exchange 30 and the second exchange 40 has not reflected the deposit in the account (or wallet) of the second user 20, the electronic device 50 no longer needs to maintain the freeze on the assets of the first exchange 30. However, the first exchange 30 may confirm that the withdrawal on the blockchain has failed, may restore the withdrawal process for the account (or wallet) of the first user 10, and may notify the first user 10 of the withdrawal failure.

If the advance reflection of the deposit at the second exchange 40 has been completed (610) and the withdrawal from the first exchange 30 is successful (611), the processor 210 may unfreeze the assets of the first exchange 30 (631). In other words, the processor 210 may release the freeze performed on at least a portion of the reserve fund of the first exchange 30 (631). Because the assets have been actually withdrawn from the first exchange 30, the corresponding assets will be deposited into the second exchange 40. In some embodiments, because an increase in assets has already been reflected in the account (or wallet) of the second user 20 (i.e., the second process has been performed), the second exchange 40 does not need to perform any additional operations. Accordingly, the processor 210 may restore the frozen assets of the first exchange 30 (i.e., may unfreeze the reserve fund of the first exchange 30). The transactions that have been withdrawn or deposited are reflected on the blockchain, and the transaction hash exists accordingly.

If the advance reflection of the deposit at the second exchange 40 has been completed (610) and the withdrawal from the first exchange 30 fails (612), the processor 210 may transfer the frozen assets of the first exchange 30 to the reserve fund of the second exchange 40 (or the reserve fund account of the second exchange 40) (632). In other words, the processor 210 may move the frozen portion of the reserve fund of the first exchange 30 to the reserve fund of the second exchange 40. Accordingly, the loss of the second exchange 40 resulting from an increase in assets already reflected in the account (or wallet) of the second user 20 (i.e., the second process is performed) may be recovered by the previously frozen assets of the first exchange 30. Because there is no withdrawal from the first exchange 30, there is no transaction to be reflected on the blockchain.

For example, a case where the advance reflection of the deposit at the second exchange 40 has been completed (610) and the withdrawal from the first exchange 30 fails (612) may include a case where a problem occurs in a block and the number of confirmations is not reached, a case where a problem such as breakdown of the network 60 occurs, a case where assets disappear from a memory pool, a case where a nonce check fails, a case where a fee for transferring assets is insufficient, and the like.

The processor 210 may record a transaction history (i.e., a deposit/withdrawal history) between the first user 10 and the second user 20 or a transaction history between the first exchange 30 and the second exchange 40 on the blockchain in various ways. For example, the processor 210 may record a transaction history on the blockchain whenever an individual transaction occurs. In some embodiments, the processor 210 may record transaction histories occurring in predefined units (e.g., a predefined number of times, a predefined period, etc.) on the blockchain at once. The processor 210 may record transaction histories occurring between the exchanges on the blockchain, regardless of whether the actual withdrawal from the first exchange 30, i.e., the asset transfer between the exchanges through the blockchain, has been successfully performed. For example, the processor 210 may record the transaction history on the blockchain even when the actual withdrawal from the first exchange 30 has failed, but the advance reflection of the deposit at the second exchange 40 has been completed, and thus, the frozen assets in the reserve fund of the first exchange 30 have been moved to the reserve fund of the second exchange 40. Accordingly, the processor 210 may also record, on the blockchain, a remittance transaction history between the first user 10 and the second user 20 occurring through the movement of the reserve fund between the exchanges, even though no actual asset transfer has occurred through the blockchain. The processor 210 may also provide the transaction histories to the exchanges or the users by recording the transaction histories between the exchanges or between the users.

FIG. 7 is a diagram illustrating an example in which the processor 210 receives second information and performs a settlement process, according to an embodiment.

FIG. 7 illustrates the operations of the first exchange 30, the electronic device 50, and the second exchange 40 described above with reference to FIGS. 3 to 6. Therefore, even when omitted below, the description provided above with respect to the first exchange 30, the electronic device 50, and the second exchange 40 may also be applied to the operations illustrated in FIG. 7.

Although FIG. 7 illustrates that the first exchange 30 performs the first process (730) after transmitting the first information to the electronic device 50 (711), the disclosure is not limited thereto, as described above with reference to FIG. 5.

Referring to FIG. 7, when the first exchange 30 transmits the first information to the electronic device 50 (711), the electronic device 50 may freeze at least a portion of the reserve fund of the first exchange 30 (720). The electronic device 50 may transmit the first information to the second exchange 40 (712).

Although FIG. 7 illustrates that the electronic device 50 transmits the first information to the second exchange 40 (712) after freezing at least a portion of the reserve fund of the first exchange 30 (720), the disclosure is not limited thereto. Alternatively, the electronic device 50 may freeze at least a portion of the reserve fund of the first exchange 30 after transmitting the first information to the second exchange 40.

The first exchange 30 may perform the first process (730), and the second exchange 40 may perform the second process (740). The first exchange 30 may notify the electronic device 50 that the first process has been completed (751). In some embodiments, the second exchange 40 may notify the electronic device 50 that the second process has been completed (752).

The first exchange 30 may transmit second information to the electronic device 50 (761). As described above with reference to FIG. 3, the second information may include a transaction hash. If the withdrawal from the first exchange 30 fails, the second information may not include a transaction hash. For example, if the movement of the assets through the blockchain is not completed within a specified time, the second information may not include a transaction hash. Accordingly, the processor 210 may confirm the actual aspect of the transfer of the assets, based on the second information. The electronic device 50 may transmit the second information to the second exchange 40 (762). Accordingly, the second exchange 40 may confirm the actual aspect of the transfer of the assets.

The electronic device 50 may perform a settlement process (770). Examples of the settlement process are the same as described above with reference to FIG. 6.

Although FIG. 7 illustrates that the electronic device 50 performs the settlement process (770) after transmitting the second information to the second exchange 40 (762), the disclosure is not limited thereto. For example, the electronic device 50 may perform the settlement process (770) at any time after receiving the second information from the first exchange 30 (761), and may also transmit the second information to the second exchange 40 (762) after performing the settlement process (770).

As described above with reference to FIGS. 6 and 7, when the first information is transmitted from the first exchange 30 to the electronic device 50, the electronic device 50 may freeze at least a portion of the reserve fund of the first exchange 30. However, the time point at which the electronic device 50 freezes the reserve fund of the first exchange 30 is not limited to the time point described above.

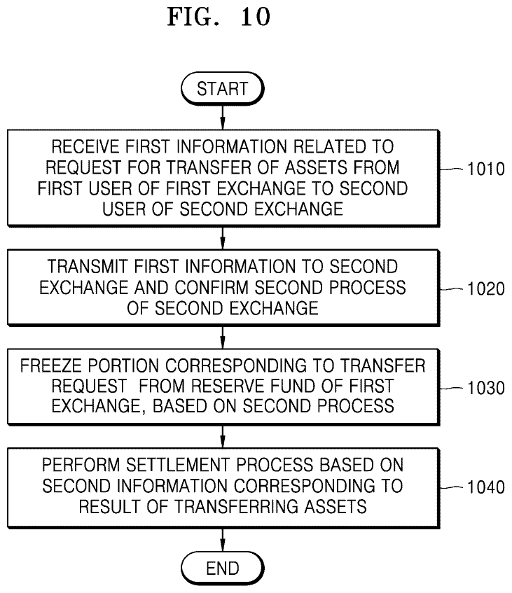

The electronic device 50 may transmit the first information to the second exchange 40, receive the result of the second process from the second exchange 40, and then freeze the reserve fund of the first exchange 30. Another example in which the electronic device 50 freezes the reserve fund of the first exchange 30 and performs the settlement process is described below with reference to FIGS. 10 to 12.

Although not illustrated in FIG. 7, the processor 210 may receive a request for travel rule verification and third information from the first exchange 30. For example, the processor 210 may receive the request for travel rule verification and the third information from the first exchange 30 before receiving the first information.

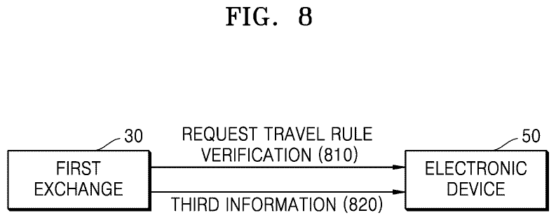

An example in which the processor 210 receives the request for travel rule verification and the third information from the first exchange 30 is described with reference to FIG. 8.

FIG. 8 is a diagram illustrating an example of the request for travel rule verification and the third information, according to an embodiment.

Referring to FIG. 8, the first exchange 30 may request the travel rule verification from the electronic device 50 (810) and may transmit the third information to the electronic device 50 (820). For example, the travel rule verification may include a process in which the electronic device 50 confirms information about an originator or a beneficiary through a solution. For example, the third information may include information about at least one of the second exchange 40, the second user 20, the address of the wallet of the second user 20 in the second exchange 40, the type of the assets for which the transfer is requested, and the quantity of the assets for which the transfer is requested.

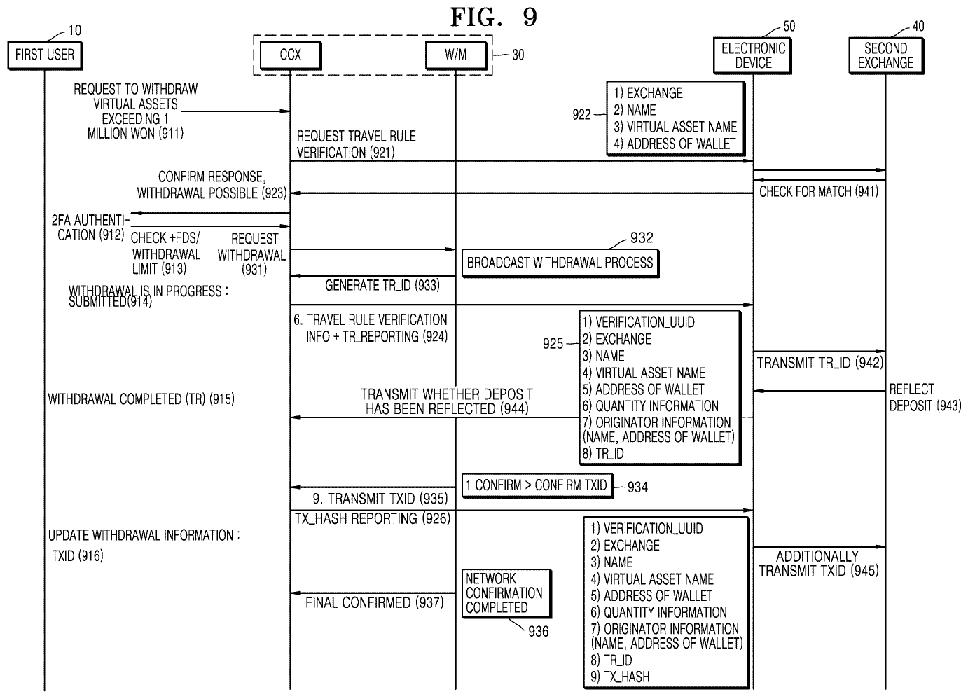

FIG. 9 is a diagram illustrating another example of a method of mediating information related to transfer of assets, according to an embodiment.

FIG. 9 illustrates the operations of the first exchange 30, the electronic device 50, and the second exchange 40 described above with reference to FIGS. 3 to 8. Therefore, even when omitted below, the description provided above with respect to the first exchange 30, the electronic device 50, and the second exchange 40 may also be applied to the operations illustrated in FIG. 9.

In FIG. 9, a contact center express (CCX) and a wallet manager (W/M) are illustrated as modules included in the first exchange 30. The CCX refers to a user interface corresponding to an online platform provided by the first exchange 30. The W/M may be understood as a module which includes a hot wallet of the first exchange 30 directly connected to the blockchain network. In other words, the W/M is a node connected to the blockchain network and may perform direct communication with the blockchain network. However, the disclosure is not limited to those illustrated in FIG. 9, and at least one of the CCX or the W/M may be another entity which is not included in the first exchange 30.

The first user 10 may request the first exchange 30 to withdraw virtual assets exceeding a preset amount (e.g., 1 million won) (911). The first exchange 30 may request the travel rule verification from the electronic device 50 (921) and may transmit the third information 922. The electronic device 50 may transmit the third information 922 to the second exchange 40. The second exchange 40 may confirm whether prestored information matches the third information 922 (941) and may transmit the confirmation result to the electronic device 50.

The first exchange 30 may receive, from the electronic device 50, a response 923 indicating that the travel rule verification and the withdrawal are possible. The first user 10 may perform two-factor authentication (912) and may check a fraud detect system (FDS) and withdrawal limit (913). The first user 10 may request a withdrawal from the first exchange 30 (931). Accordingly, an indication that the withdrawal requested by the first user 10 is in progress may be output on a terminal of the first user 10 (914). In some embodiments, the first exchange 30 may reflect a decrease in assets in the wallet of the first user 10 (i.e., may perform the first process).

The first exchange 30 may broadcast a withdrawal process (932) and may generate an identifier TR_ID corresponding to the transfer request (933). For example, the identifier TR_ID may be the same as described above with reference to FIG. 3. The first exchange 30 may transmit information about travel rule verification and first information 925 to the electronic device 50 (924). In FIG. 9, the transmission of the first information 925 is referred to as “TR-Reporting.” Upon receiving the first information, the electronic device 50 may freeze a portion of the reserve fund of the first exchange 30 corresponding to the transfer of the assets from the first user 10 to the second user 20.

The electronic device 50 may transmit the identifier TR_ID to the second exchange 40 (942). For example, the electronic device 50 may transmit the first information including the identifier TR_ID to the second exchange 40. Upon receiving the identifier TR_ID, the second exchange 40 may recognize that the movement of assets corresponding to the asset transfer request from the first user 10 to the second user 20 will proceed from the first exchange 30 to the second exchange 40 through the blockchain. Accordingly, the second exchange 40 may reflect the deposit of the corresponding assets in the wallet (or account) of the second user 20 in response to receiving the identifier TR_ID (943). In other words, the second exchange 40 may reflect an increase in assets in the wallet of the second user 20 (i.e., may perform the second process). The second exchange 40 may reflect the deposit in the wallet of the second user 20 and may transmit information related to the reflection of the deposit, for example, the success or failure of the reflection of the deposit, to the electronic device 50.

The electronic device 50 may transmit, to the first exchange 30, whether the deposit has been reflected by the second exchange 40 (944). The withdrawal of the assets of the first user 10 may be completed (915) either before or after this transmission.

The first exchange 30 may confirm a transaction ID according to a confirmation (934) and may transmit the transaction ID (935). Accordingly, the first user 10 may confirm the transaction ID through a user interface. Withdrawal information may be updated and output on the user interface of the first user 10 (916).

The first exchange 30 may transmit second information to the electronic device 50 (926). In FIG. 9, the transmission of the second information (926) is referred to as “Tx_hash reporting.” In some embodiments, the second information may include a transaction hash TX_hash described above with reference to FIG. 6. Upon receiving the second information, the electronic device 50 may confirm whether the movement of the assets from the first exchange 30 to the second exchange 40 has actually occurred through the blockchain, and accordingly, may perform the settlement process described above with reference to FIG. 6.

The electronic device 50 may additionally transmit the transaction ID to the second exchange 40 (945).

Upon completing the network confirmation (936), the first exchange 30 may notify that the final confirmation for the transfer of the assets has been completed (937). Accordingly, the first user 10 may confirm that the final confirmation of the transfer of the assets has been completed through the user interface.

FIG. 10 is a flowchart showing another example of a method of mediating information related to transfer of assets, according to an embodiment.

The method illustrated in FIG. 10 may include operations which are processed in time series by the electronic device 50, the server 200, or the processor 210 illustrated in FIGS. 1 and 2. Therefore, even when omitted below, the description of the electronic device 50, the server 200, or the processor 210 illustrated in FIGS. 1 and 2 may also be applied to the method illustrated in FIG. 10.

Operations 1010 and 1040 of FIG. 10 correspond to operations 310 and 340 of FIG. 3, respectively. Therefore, detailed descriptions of operations 1010 and 1040 of FIG. 10 are omitted below.

In operation 1020, the processor 210 may transmit the first information to the second exchange 40 and may confirm the second process of the second exchange 40.

For example, the processor 210 may transmit, to the second exchange 40, the first information received from the first exchange 30. By receiving the first information, the second exchange 40 may confirm that the first user 10 has requested the transfer of the assets to the second user 20. Accordingly, the second process may be performed at the second exchange 40.

The processor 210 may receive information about the result of performing the second process from the second exchange 40. For example, the result of performing the second process may refer to a process in which an increase in assets for which the transfer is requested is reflected or not reflected in the wallet (or account) of the second user 20 in the second exchange 40.

In operation 1030, the processor 210 may freeze a portion corresponding to the transfer request from the reserve fund of the first exchange 30, based on the second process.

For example, the processor 210 may freeze at least a portion of the reserve fund of the first exchange 30 in response to receiving the result of performing the second process. As described above with reference to FIGS. 6 and 7, the processor 210 may freeze the reserve fund of the first exchange 30 in response to receiving the first information. However, the time point at which the reserve fund of the first exchange 30 is frozen is not limited to the time point described above, and the processor 210 may also freeze the reserve fund of the first exchange 30 after receiving the result of performing the second process. Accordingly, the result of the settlement process performed by the processor 210 may be different from the description provided above with reference to FIG. 6.

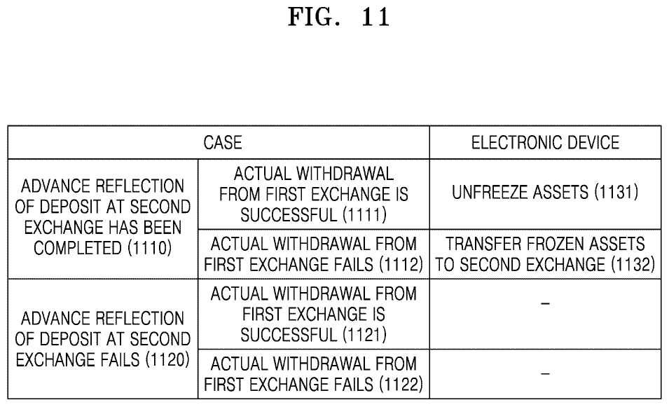

Hereinafter, an example in which the settlement process is performed according to the flowchart illustrated in FIG. 10 is described with reference to FIG. 11.

FIG. 11 is a diagram illustrating another example in which the processor 210 performs the settlement process according to the actual aspect of the transfer of the assets, according to an embodiment.

As in operation 1040 of FIG. 10, the processor 210 may perform the settlement process depending on whether the withdrawal of the assets for which the transfer is requested has been completed at the first exchange 30. In other words, the processor 210 may perform the settlement process according to the actual success or failure of the withdrawal from the first exchange 30.

Compared to the examples illustrated in FIG. 6, the examples illustrated in FIG. 11 differ in that the reserve fund of the first exchange 30 is frozen after the processor 210 receives the result of the second process from the second exchange 40. For example, the processor 210 may determine whether to freeze the reserve fund of the first exchange 30 after confirmation of the second process.

Hereinafter, it is assumed that the assets for which the transfer is requested are virtual assets. The processor 210 may confirm whether the advance reflection of the deposit at the second exchange 40 has been completed through the second process completion notification from the second exchange 40.

As an example, if the advance reflection of the deposit at the second exchange 40 has been completed (1110), the processor 210 may freeze the assets of the first exchange 30. After the assets of the first exchange 30 are frozen, the processor 210 may perform a settlement process based on the second information corresponding to the result of transferring the assets.

If the withdrawal from the first exchange 30 is successful (1111), the processor 210 may unfreeze the assets of the first exchange 30 (1131). In other words, the processor 210 may release the freeze performed on at least a portion of the reserve fund of the first exchange 30 (1131). Because the assets have been actually withdrawn from the first exchange 30, the assets are deposited into the second exchange 40. In some embodiments, because an increase in assets has already been reflected in the account (or wallet) of the second user 20 (i.e., the second process has been performed), the second exchange 40 has only to transfer the deposited assets to the account (or wallet) of the second user 20. Accordingly, the processor 210 may restore the frozen assets of the first exchange 30 (i.e., may unfreeze the reserve fund of the first exchange 30). The transactions that have been withdrawn or deposited are reflected on the blockchain, and the transaction hash exists accordingly.

If the withdrawal from the first exchange 30 fails (1112), the processor 210 may transfer the frozen assets of the first exchange 30 to the reserve fund of the second exchange 40 (or the reserve fund account of the second exchange 40) (1132). In other words, the processor 210 may move the frozen portion of the reserve fund of the first exchange 30 to the reserve fund of the second exchange 40. Accordingly, the loss of the second exchange 40 resulting from an increase in assets already reflected in the account (or wallet) of the second user 20 (i.e., the second process is performed) may be recovered by the previously frozen assets of the first exchange 30. Because there is no withdrawal from the first exchange 30, there is no transaction to be reflected on the blockchain.

A case where the advance reflection of the deposit at the second exchange 40 has been completed (1110) and the withdrawal from the first exchange 30 fails (1112) is the same as described above with reference to FIG. 6.

As an example, if the advance reflection of the deposit at the second exchange 40 fails (1120), the processor 210 may not freeze the assets of the first exchange 30. In this case, the processor 210 may not perform a separate settlement process. Whether an increase in assets is reflected in the account (or wallet) of the second user 20 depends on whether the assets have been actually withdrawn from the first exchange 30.

If the withdrawal from the first exchange 30 is successful (1121), the processor 210 may not perform a separate settlement process. Because the assets have been actually withdrawn from the first exchange 30, the assets are deposited into the second exchange 40. Therefore, as the assets are deposited, the second exchange 40 may perform the process of depositing the assets into the account (or wallet) of the second user 20 without intervention of the electronic device 50. The transactions that have been withdrawn or deposited are reflected on the blockchain, and the transaction hash exists accordingly.

If the withdrawal from the first exchange 30 fails (1122), the processor 210 may not perform a separate settlement process. In other words, because no assets have been actually withdrawn from the first exchange 30 and the second exchange 40 has not reflected the deposit in the account (or wallet) of the second user 20, the processor 210 does not need to perform a separate settlement process. However, the first exchange 30 may confirm that the withdrawal on the blockchain has failed, may restore the withdrawal process for the account (or wallet) of the first user 10, and may notify the first user 10 of the withdrawal failure.

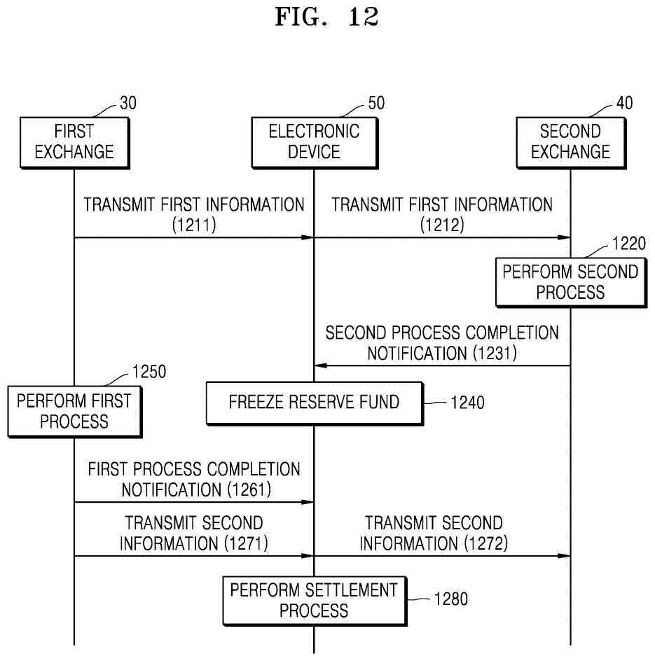

FIG. 12 is a diagram illustrating another example in which the processor 210 receives second information and performs a settlement process, according to an embodiment.

FIG. 12 illustrates the operations of the first exchange 30, the electronic device 50, and the second exchange 40 described above with reference to FIGS. 9 and 10. Therefore, even when omitted below, the description provided above with respect to the first exchange 30, the electronic device 50, and the second exchange 40 may also be applied to the operations illustrated in FIG. 12.

Although FIG. 12 illustrates that the first exchange 30 performs the first process (1250) after transmitting the first information to the electronic device 50 (1211), the disclosure is not limited thereto, as described above with reference to FIG. 5.

Referring to FIG. 12, when the first exchange 30 transmits the first information to the electronic device 50 (1211), the electronic device 50 may transmit the first information to the second exchange 40 (1212).

The second exchange 40 may perform the second process (1220) and notify the electronic device 50 that the second process has been completed (1231). Completion of the second process may indicate that an increase in assets for which the transfer is requested has either been reflected or not reflected in the wallet (or account) of the second user 20 in the second exchange 40.

The electronic device 50 may freeze at least a portion of the reserve fund of the first exchange 30 in response to receiving a second process completion notification (1240). The first exchange 30 may perform the first process (1250) and notify the electronic device 50 that the first process has been completed (1261). Completion of the first process may indicate that a decrease in assets for which the transfer is requested has either been reflected or not reflected in the wallet (or account) of the first user 10 in the first exchange 30.

Although FIG. 12 illustrates that the electronic device 50 performs the first process (1250) after freezing at least a portion of the reserve fund of the first exchange 30 (1240), the disclosure is not limited thereto. For example, the first process may be performed before the reserve fund of the first exchange 30 is frozen.

The first exchange 30 may transmit second information to the electronic device 50 (1271). If the withdrawal from the first exchange 30 fails, the second information may omit a transaction hash. For example, if the transfer of assets through the blockchain is not completed within a specified time, the second information may not include a transaction hash. Accordingly, the processor 210 may confirm the actual aspect of the transfer of the assets, based on the second information. The electronic device 50 may transmit the second information to the second exchange 40 (1272). Accordingly, the second exchange 40 may confirm the actual aspect of the transfer of the assets.

The electronic device 50 may perform a settlement process (1280). Examples of the settlement process are the same as described above with reference to FIG. 11.

Although FIG. 12 illustrates that the electronic device 50 performs the settlement process (1280) after transmitting the second information to the second exchange 40 (1272), the disclosure is not limited thereto. The electronic device 50 may perform the settlement process (1280) at any time after receiving the second information from the first exchange 30 (1271). In some embodiments, the electronic device 50 may transmit the second information to the second exchange 40 (1272) after performing the settlement process (1280).

As described above, the processor 210 may operate so that the withdrawal is immediately reflected in the account (or wallet) of the originator (i.e., a decrease in assets is immediately reflected) and the deposit is immediately reflected in the account (or wallet) of the beneficiary (i.e., an increase in assets is immediately reflected). Therefore, the time required for transferring the assets may be reduced.

The withdrawal may be immediately reflected in the account (or wallet) of the originator and the deposit may be immediately reflected in the account (or wallet) of the beneficiary. The immediate reflection of both withdrawal and deposit results in a technical effect of reducing overall transfer latency for users.

Furthermore, there is a technical effect that may supplement the trust between transferring entities through a third party, such as a transaction mediator, while reducing the time required for the deposit to be reflected to the beneficiary, i.e., the time required for the transfer of assets to be completed.

The methods described above may be written as a program that is executable on a computer, and may be implemented in a general-purpose digital computer that operates the program by using a computer-readable recording medium. Furthermore, data structures used in the methods described above may be recorded on a computer-readable recording medium through a variety of means. The computer-readable recording medium may include a storage medium, such as a magnetic storage medium (e.g., read-only memory (ROM), random access memory (RAM), universal serial bus (USB), floppy disk, hard disk, etc.) and an optical reading medium (e.g., compact disc-ROM (CD-ROM), digital versatile disc (DVD), etc.).

Unlike conventional systems that merely transmit user requests for asset transfers between virtual asset service providers (VASPs), the methods described above ensure compliance with the “Travel Rule” while maintaining security, trust, and speed in inter-exchange transactions.

More specifically, the invention improves computer functionality by implementing an automated reserve fund freezing mechanism and a dual-process verification system that confirms both withdrawal and deposit statuses before executing settlement. This prevents double-spending, enhances the reliability of asset transfer operations, and reduces latency, thereby improving the overall functionality of the networked computing system.

Those of ordinary skill in the art will understand that the disclosure may be implemented in modified forms without departing from the essential features of the disclosure. Therefore, the disclosed methods should be considered in an illustrative sense rather than a restrictive sense. The scope of the disclosure is indicated in the claims rather than the foregoing description, and all differences within the scope equivalent thereto should be construed as falling within the scope of the disclosure.

What is claimed is:

1. A method, performed by an electronic device, of mediating information related to transfer of assets, the method comprising:
receiving first information related to a request for the transfer of the assets from a first user of a first exchange to a second user of a second exchange;
freezing a portion of a reserve fund of the first exchange, based on the first information;
transmitting the first information to the second exchange; and
performing a settlement process based on second information corresponding to a result of the transfer of the assets.

2. The method of claim 1, wherein the performing of the settlement process comprises processing the frozen portion based on whether a withdrawal of the assets requested for transfer has been completed at the first exchange.

3. The method of claim 2, wherein the performing of the settlement process comprises, if the withdrawal of the assets requested for transfer has not been completed at the first exchange, moving the frozen portion to the reserve fund of the second exchange.

4. The method of claim 1, wherein the first information is a basis for updating a balance of the second exchange for the second user.

5. The method of claim 1, wherein the second information comprises a transaction hash generated upon completion of the transfer of the assets.

6. The method of claim 1, wherein the request for the transfer of the assets comprises a request for transfer of assets equal to or greater than a preset amount.

7. The method of claim 1, wherein the request for the transfer of the assets comprises a request subject to a travel rule established for the transfer of the assets.

8. The method of claim 1, further comprising confirming a first process of the first exchange related to the assets requested for transfer and a second process of the second exchange related to the assets requested for transfer.

9. The method of claim 7, wherein the first process comprises a process in which a decrease in the assets requested for transfer is reflected in a wallet of the first user in the first exchange, and
the second process comprises a process in which an increase in the assets requested for transfer is reflected in a wallet of the second user in the second exchange.

10. The method of claim 1, wherein the first information comprises information about at least one of:
an identifier corresponding to travel rule verification;
the second exchange;
the second user;
an address of a wallet of the second user in the second exchange;
a type of the assets requested for transfer;
a quantity of the assets requested for transfer;
the first user;
an address of a wallet of the first user in the first exchange; and
an identifier corresponding to the request for the transfer of the assets.

11. The method of claim 1, further comprising receiving a request for travel rule verification and third information from the first exchange,
wherein the third information comprises information about at least one of:
the second exchange, the second user;
an address of a wallet of the second user in the second exchange;
a type of the assets requested for transfer; and
a quantity of the assets requested for transfer.

12. A non-statutory computer-readable recording medium having recorded thereon a program for causing a computer to perform the method of claim 1.

13. An electronic device comprising:
a memory in which at least one program is stored; and
a processor configured to execute the at least one program to perform at least one operation,
wherein the processor is further configured to:
obtain first information related to a request for transfer of assets from a first user of a first exchange to a second user of a second exchange;
freeze a portion of a reserve fund of the first exchange, based on the first information;
transmit the first information to the second exchange; and
perform a settlement process based on second information corresponding to a result of the transfer of the assets.

14. The electronic device of claim 13, wherein the processor is further configured to process the frozen assets based on whether a withdrawal of the assets requested for transfer has been completed at the first exchange.

15. The electronic device of claim 14, wherein the processor is further configured to, if the withdrawal of the assets requested for transfer has not been completed at the first exchange, move the frozen portion to the reserve fund of the second exchange.

16. The electronic device of claim 13, wherein the second information comprises a transaction hash generated upon completion of the transfer of the assets requested for transfer.

17. The electronic device of claim 13, wherein the request for the transfer of the assets comprises a request to transfer assets equal to or greater than a preset amount.

18. The electronic device of claim 13, wherein the processor is further configured to confirm a first process of the first exchange related to the assets requested for transfer and a second process of the second exchange related to the assets for which the transfer is requested.

19. The electronic device of claim 18, wherein the first process comprises a process in which a decrease in the assets requested for transfer is reflected in a wallet of the first user in the first exchange, and
the second process comprises a process in which an increase in the assets requested for transfer is reflected in a wallet of the second user in the second exchange.

20. The electronic device of claim 13, wherein the first information comprises information about at least one of:
an identifier corresponding to travel rule verification;
the second exchange;
the second user;
an address of a wallet of the second user in the second exchange;
a type of the assets requested for transfer;
a quantity of the assets requested for transfer;
the first user;
an address of a wallet of the first user in the first exchange; and
an identifier corresponding to the request for the transfer.
